(19) United States
(12) Patent Application Publication
(10) Pub. No.: US 2010/0006525 A1
(43) Pub. Date: Jan. 14, 2010

(54) SHELVING SYSTEM

(76) Inventors: Michael John Goodridge, Queensland (AU); Maurice George Newbery, Queensland (AU)

Correspondence Address: TAROLLI, SUNDHEIM, COVELL & TUMMINO L.L.P., 1300 EAST NINTH STREET, SUITE 1700, CLEVEVLAND, OH, 44114, US

(21) Appl. No.: 12/305,487

(22) PCT Filed: Jun. 22, 2007
(86) PCT No.: PCT/AU2007/000874

§ 371 Date: Dec. 18, 2008

(30) Foreign Application Priority Data
Jun. 22, 2006 (AU) 2006903371

(51) Int. Cl. A47F 5/08; A47B 96/06; B23P 11/00

(52) U.S. Cl. 211/134; 248/201; 29/428

(57) ABSTRACT

A shelving system comprising a wall bracket having a wall attachment portion and a wall connecting portion; and a shelf bracket having a shelf attachment portion and a shelf connecting portion; wherein the wall connecting portion and the shelf connecting portion interlock.

### FIELD OF THE INVENTION

This invention relates to a shelving system. In particular, the invention relates to a shelving system to allow for efficient and effective installation of domestic and commercial shelving.

### BACKGROUND OF THE INVENTION

Shelving systems are required in many applications domestic and commercial applications. For example houses and units required wardrobe shelving whilst retail shops require shelves for storage and display purposes.

A major cost of the purchase of shelving is the installation cost. The cost of installing shelving is proportional to the amount of time spent on the installation. Hence, if shelves can be installed quickly then the cost of the shelving will be lower. Many retail clothing stores are therefore moving to wire shelving which is quicker to install than traditional solid shelving systems.

The problem with wire shelving is that it is often perceived as being not as strong as solid shelving. Further, wire shelving does not provide the aesthetic appeal of solid shelving. Therefore, if solid shelving could be installed quickly and effectively in order to reduce the price of solid shelving, many people would choose solid shelving systems over wire shelving systems.

### OBJECT OF THE INVENTION

It is an object of the invention to overcome and alleviate one or more of the above disadvantages or provide the consumer with a useful or commercial choice.

### SUMMARY OF THE INVENTION

In one form, although not necessarily the only or broadest form, the invention resides in a shelving system comprising:

a wall bracket having a wall attachment portion and a wall connecting portion; and

a shelf bracket having a shelf attachment portion and a shelf connecting portion;

wherein the wall connecting portion and the shelf connecting portion interlock.

The wall attachment portion may include a at least one fixing hole. A fastener, such a screw, may be placed through the fixing hole.

The wall connecting portion may include a male member. The male member may be in the form of a wall connecting barb.

The wall bracket may also include a locking portion. The locking portion may assist in holding the wall bracket to the shelf.

The shelf attachment portion may be a channel. The channel may be U-shaped.

The shelf connecting portion may include a female member. The female member may include a shelf connecting barb.

The shelving system may include a shelf brace. The shelf brace may support the shelf.

In another form the invention resides in a method of installing a shelving system including the steps of:

fixing at least one wall bracket, the wall bracket having a wall attachment portion and a wall connecting portion, to a wall via the wall connecting portion;

attaching at least one shelf bracket, the shelving unit having a shelf attachment portion and a shelf connecting portion, to a shelf via the shelf attachment portion; and

interlocking at least one wall connecting portion to at least one shelf connecting portion.

The method of installation may also include one or more of the steps of:

marking placement locations for wall brackets on the wall;

fixing a locking portion of the wall bracket to the shelf;

fixing at least one shelf brace to a wall to support the shelf; and.

fixing at least one hanging rod bracket to a wall to support a rod.

### BRIEF DESCRIPTION OF THE DRAWINGS

An embodiment of the invention, by way of example only, will be described with reference to the accompanying drawings in which:

FIG. 1 shows a perspective view of a shelving system according to an embodiment of the invention;

FIG. 2A shows a front perspective view of a wall bracket according to an embodiment of the invention;

FIG. 2B shows a rear perspective view of a wall bracket according to FIG. 2A;

FIG. 2C shows a plan view of a wall bracket according to FIG. 2A;

FIG. 2D shows a side view of a wall bracket according to FIG. 2A;

FIG. 2E shows a front view of a wall bracket according to FIG. 2A;

FIG. 3 shows a side view of a shelf bracket according to an embodiment of the invention;

FIG. 4A shows a perspective view of wall bracket before being connected to a shelf bracket;

FIG. 4B shows a side view of a wall bracket connected to a shelf bracket;

FIG. 5A shows a perspective view of a shelf brace according to an embodiment of the invention;

FIG. 5B shows a side view of a shelf brace according to FIG. 5A;

FIG. 5C shows a front view of a shelf brace according to FIG. 5A;

FIG. 6A shows a perspective view of a hanging rod bracket according to an embodiment of the invention;

FIG. 6B shows a bottom view of the hanging rod of FIG. 6A;

FIG. 6C shows a front view of the hanging rod of FIG. 6A;

FIG. 6D shows a side view of the hanging rod of FIG. 6A;

FIG. 7A shows a front perspective view of a wall bracket according to an embodiment of the invention; and

FIG. 7B shows a rear perspective view of a wall bracket according to FIG. 7A.

### DETAILED DESCRIPTION OF THE PREFERRED EMBODIMENT

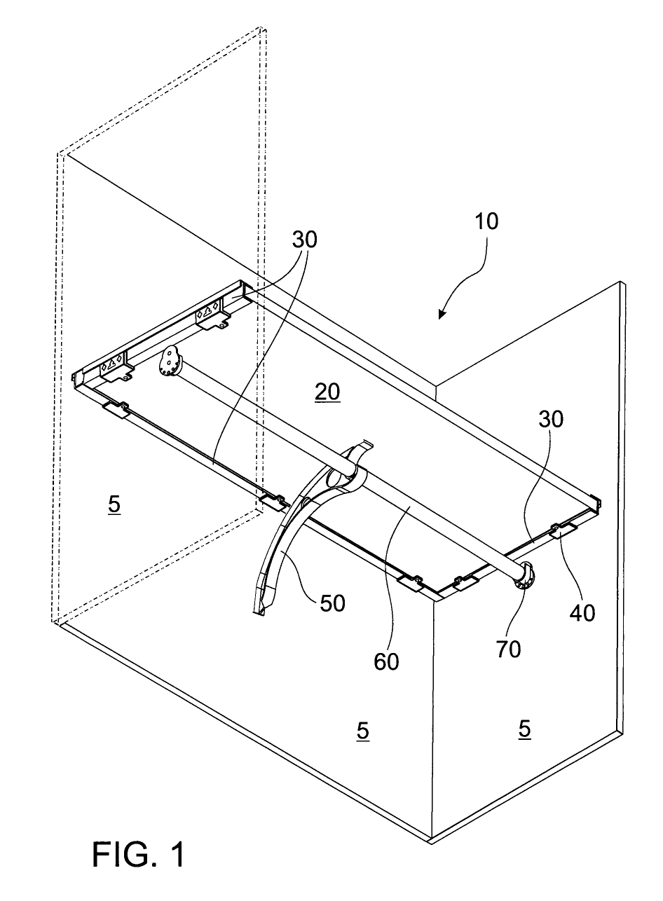

FIG. 1 shows a perspective view of a shelving system 10 for the storage of clothing according to an embodiment of the invention. The shelving system includes a shelf 20, three shelf brackets 30, seven wall brackets 40, a shelf brace 50, a rod 60 and two rod brackets 70.

In this embodiment, the shelf 20 is a solid shelf and is made of melamine. However, it should be appreciated that the shelf 20 may be made of other materials such as wood.

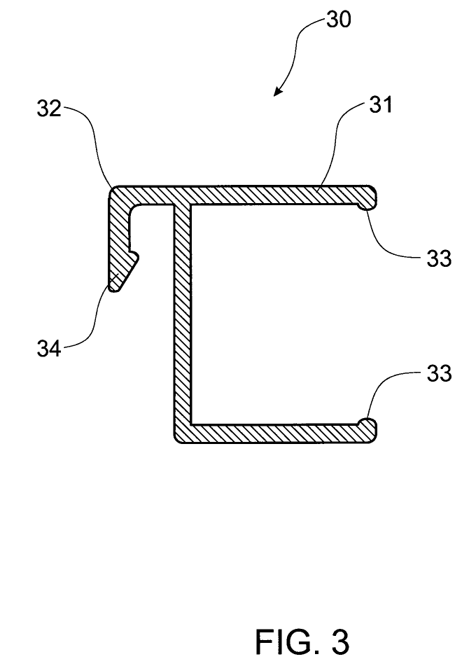

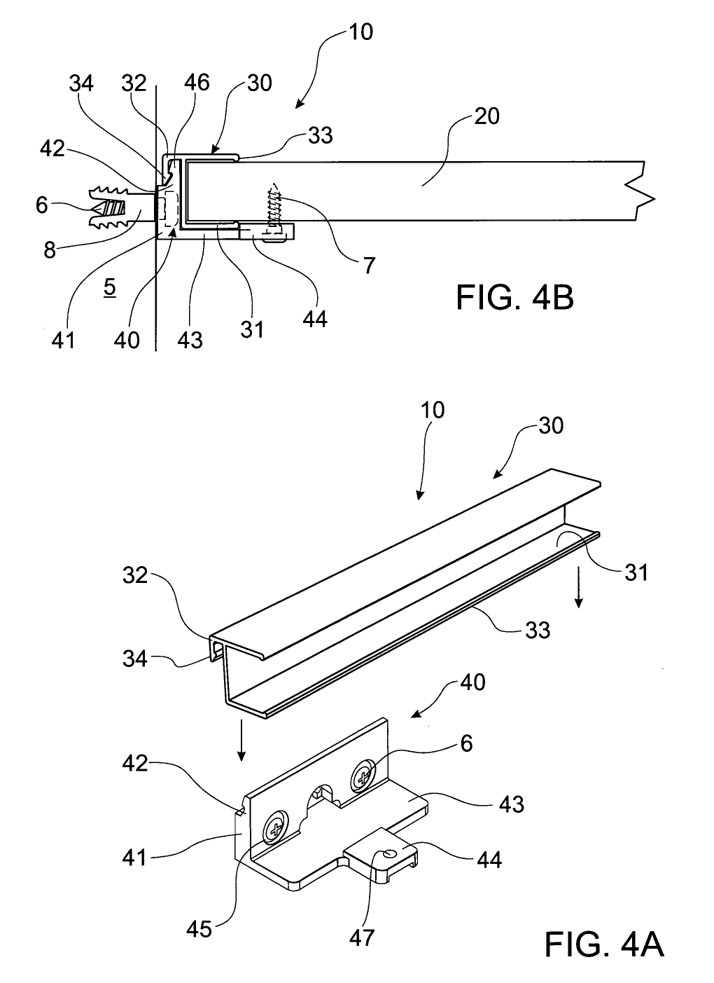

There are three shelf brackets 30 shown in more detail in FIG. 3. Each shelf bracket extends along the length of an edge of the shelf 20. It should be appreciated that the number of shelf brackets will be variable depending on the angle of the walls the shelving system 10. Each shelf bracket 30 includes a shelf attachment portion 31 and a shelf connecting portion 32. The shelf attachment portion 31 is U-shaped and is placed over an edge of the shelf 20. Nodes 33 are located at the ends of the shelf attachment portion 31 to assist in holding the shelf bracket 30 to the shelf 20. The shelf connecting portion 32 extends outwardly from the shelf attachment portion 31. A shelf connecting barb 34 is located at the end of the attachment portion 31.

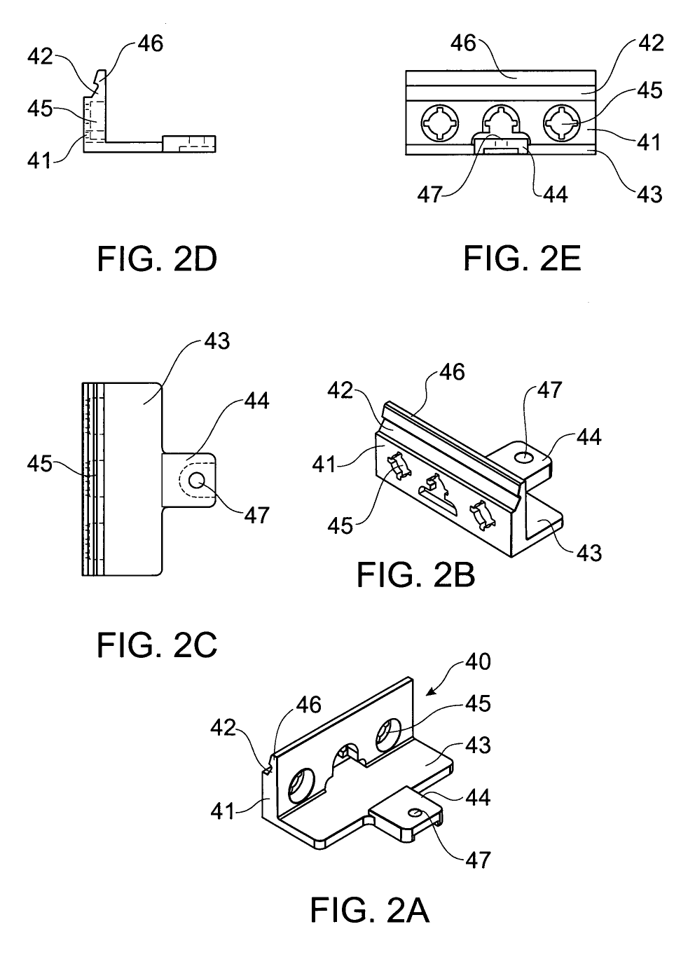

There are seven wall brackets 40 commensurate with the size of the shelf 20. It should be appreciated that the number of wall brackets 40 may be varied according to the size of the shelf 20. FIGS. 2A to 2E show a wall bracket in further detail.

Each wall bracket 40 includes a wall attachment portion 41, a wall connection portion 42, a supporting portion 43 and a locking portion 44. The wall attachment portion 41 includes three recessed wall fastening holes 45 through which fasteners are located to secure the wall bracket 40 to a wall 5. The wall connection portion 42 extends upwardly from the wall attachment portion 41. A wall connecting barb 46 is located at the end of the wall connection portion 42. The supporting portion 43 assists in supporting the shelf 20. The shelf locking portion 44 assists in holding the wall bracket to the shelf and extends outwardly from the supporting portion 43. The shelf locking portion is higher than the adjacent supporting portion 43. A fastening hole 47 is located through the locking portion 44 to allow a fastener to engage the shelf 20.

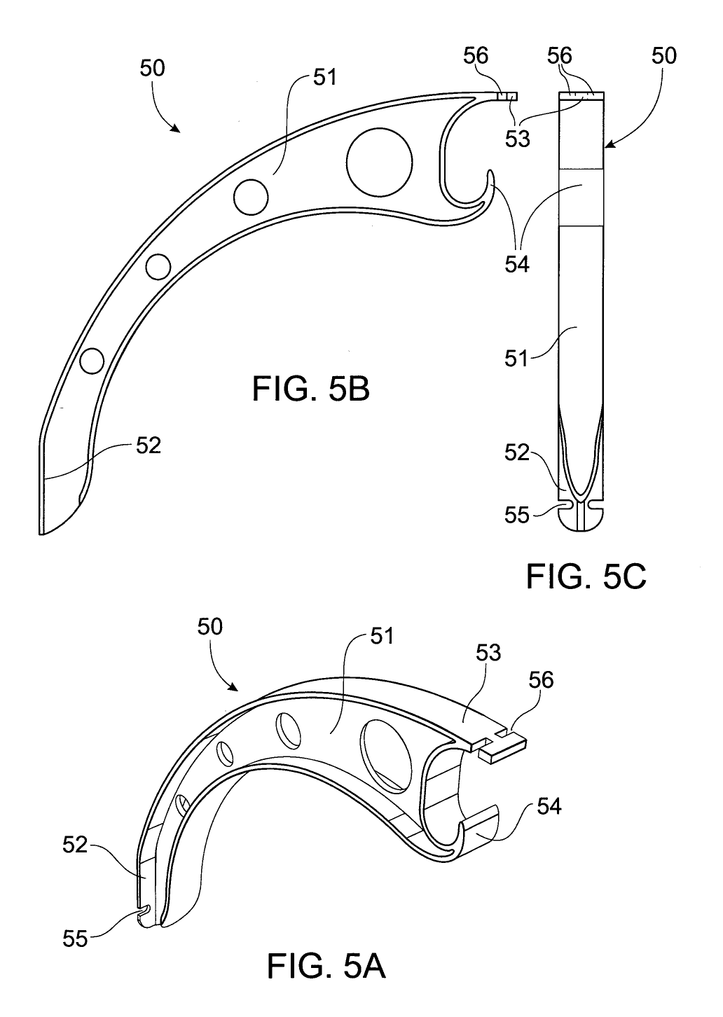

The shelf brace 50, shown in more detail in FIGS. 5A to 5C, is used to support the shelf 20. The shelf brace 50 includes a main brace body 51, a wall fixing portion 52, a shelf fixing portion 53 and a hanging rod hook 54. Wall fastener apertures 55 are located within the wall fixing portion 52 and shelf fastener apertures 56 are located within the shelf fixing portion 53. The hanging rod hook 54 is located below the shelf fixing portion 53.

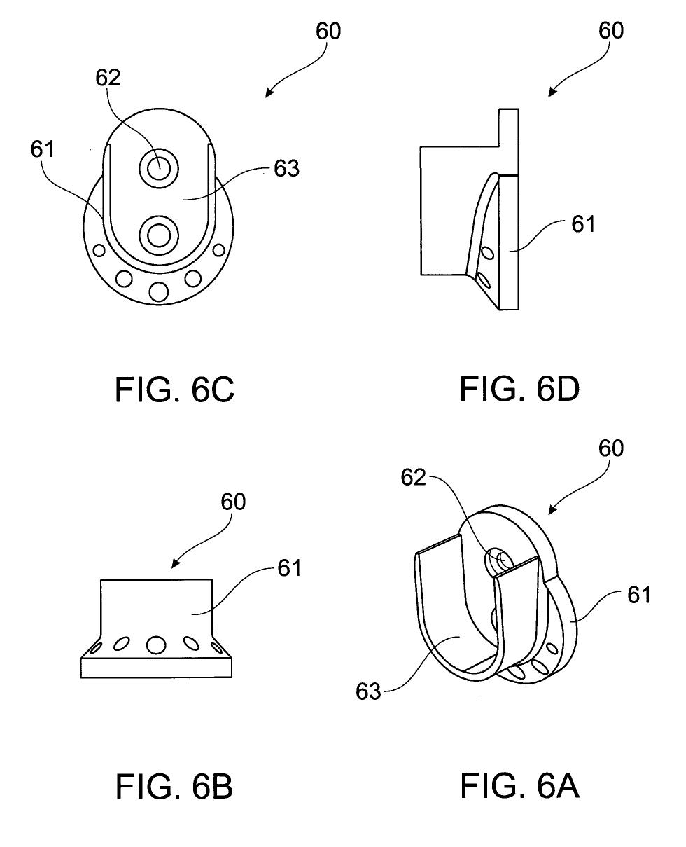

Two hanging rod brackets 60, shown in FIGS. 6A to 6D, are located on opposing walls 5. Each of the hanging rod brackets 60 include a bracket body 61 and two recessed fastening holes 62. The bracket body includes a U-shaped recess 63 to hold the connection rod 70. The two fastening holes 62 allow fasteners to be used to connect the hanging rod to a wall 5.

In order to install the shelving system 10, the size of a shelf 20 is determined by measuring a space between walls 5. The shelf 20 is then cut to size. The number of shelf brackets 30 and wall brackets 40 are chosen depending on the use of the shelf 20. A template (not shown) is then used to determine the spacing for the wall brackets 40 along the wall 5 and drill holes are made in the walls 5. A wall bracket 40 is placed on the wall 5 over the drill holes and a wall anchor 8 is pushed through each of the fastening holes 45 of the wall bracket attachment portion 41 into the wall 5. Fasteners 6 are then screwed into the wall anchor 8 expanding the wall anchor 8 within the wall 5 to hold the wall brackets 40 in place.

The shelf brackets 30 are then attached around the shelf 20 via the shelf attachment portions 31. The nodes 33 assist holding the shelf bracket 30 to the shelf 20. The shelf brackets 30 are elongate and therefore do not require precise positioning on the shelf 20. Once the shelf brackets 30 have been placed on the shelf 20, the shelf brackets 30 are placed onto respective wall brackets 40. Placement a the shelf brackets 30 onto a wall bracket 40 is completed by moving the shelf connection portion 32 over the wall connection portion 42. The shelf bracket 30 is then moved downwardly with respect to the wall bracket so that the shelf connecting barb 34 engages with the wall connecting barb 46 to hold the shelf bracket 30 and wall bracket together. The wall connection portion 42 is spaced from the wall 5 a sufficient distance so that the shelf connection portion 32 can be placed over the wall connection portion without the need for scraping the wall 5.

When the wall connection portion 42 and shelf connection portion 32 are engaged, the shelf attachment portion 31 sits on top of the support portion 43. This allows the locking portion to sit substantially flush with an underside of the shelf 20. A fastener 7 can therefore be placed through the fastener hole 47 and into the shelf 20 to hold the shelf 20 in position.

The shelf brace 50 is then fitted by placing the bracket against the shelf 20 and against the wall 5. Fasteners are then placed through the wall fastener apertures 55 into the wall 5 and through the shelf fastener apertures 56 into the shelf 20. It should be appreciated that the shelf brace 50 may not be required in some shelving systems.

Two hanging brackets 60 are then fastened to the wall 5 by fasteners placed through the fastening holes 62. The hanging brackets are placed on the wall 5 so they are in alignment with the hanging rod hook 54. A hanging rod 70 is placed within the U-shaped recess 63 on the two hanging brackets 60 and through the hanging rod hook 54 of the shelf brace 50 to complete the shelving system 10. It should be appreciated that the hanging rod and hanging brackets are optional.

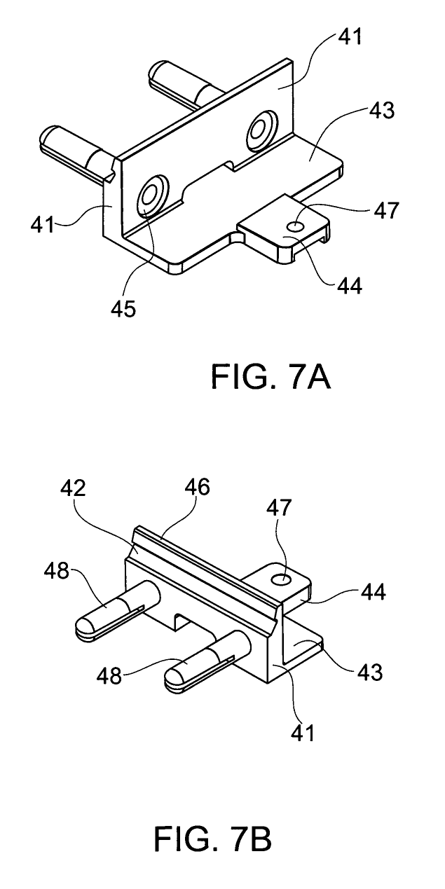

FIGS. 7A and 7B show an alternative wall bracket 40. The wall bracket 40 show in FIGS. 7A and 7B is very similar to the wall bracket shown in the FIGS. 2A to 2E. Accordingly like numerals have been used to represent like features of the wall bracket. The only difference between the wall brackets 40 is that the wall bracket of FIGS. 7A and 7B has two integrally formed wall plugs 48 that extend rearwardly from the wall attachment portion 41. The wall plugs 48 are aligned with the fastening holes 45.

In use the wall bracket 40 shown in FIGS. 7A and 7B can be installed rapidly as separate wall plugs are not required to be placed within a wall prior to fastening of the wall bracket 40 to the wall as the wall plugs 48 form part of the wall bracket 40.

The shelving system 10 allows for a quick and effective method of producing shelving. This system reduces the time needed for installation of shelving and therefore the overall cost of shelving is reduced.

It should be appreciated that various other changes and modifications may be made to the embodiments described without departing from the spirit or scope of the invention.

1. A shelving system comprising:
a wall bracket having a wall attachment portion and a wall connecting portion; and
a shelf bracket having a shelf attachment portion and a shelf connecting portion;
wherein the wall connecting portion and the shelf connecting portion interlock.

2. A shelving system of claim 1 wherein the wall attachment portion includes a at least one fixing hole.

3. A shelving system of claim 1 wherein the wall connecting portion includes a male member.

4. A shelving system of claim 3 wherein the male member is in the form of a wall connecting barb.

5. A shelving system of claim 1 wherein the wall bracket includes a locking portion.

6. A shelving system of claim 1 wherein the wall bracket includes at least one wall plug.

7. A shelving system of claim 1 wherein the shelf attachment portion is channel.

8. A shelving system of claim 7 wherein the channel is U-shaped.

9. A shelving system of claim 7 wherein he shelf connecting portion includes a female member.

10. A shelving system of claim 9 wherein the female member includes a shelf connecting barb.

11. A shelving system of claim 1 wherein the shelving system includes a shelf brace.

12. A method of installing a shelving system including the steps of:
fixing at least one wall bracket, the wall bracket having a wall attachment portion and a wall connecting portion, to a wall via the wall connecting portion;
attaching at least one shelf bracket, the shelving unit having a shelf attachment portion and a shelf connecting portion, to a shelf via the shelf attachment portion; and
interlocking at least one wall connecting portion to at least one shelf connecting portion.

13. The method of claim 12 including the step of marking placement locations for wall brackets on the wall.

14. The method of claim 12 including the step of fixing a locking portion of the wall bracket to the shelf.

15. The method of claim 12 including the step of fixing at least one shelf brace to a wall to support the shelf.

16. The method of claim 12 including the step of fixing at least one hanging rod bracket to a wall to support a rod.
